(19) United States
(12) Patent Application Publication
(10) Pub. No.: US 2026/0055605 A1
(43) Pub. Date: Feb. 26, 2026

(54) EXTERIOR WALL AND ROOFING DECK STRUCTURES MADE USING LIGHTWEIGHT COMPOSITE SHEATHING PANELS

(71) Applicant: HYDROBLOK, INC., Park City, UT (US)

(72) Inventors: Zhongsheng CHEN, Draper, UT (US); Brian DUNN, Draper, UT (US); Alex GILLESPIE, Draper, UT (US)

(21) Appl. No.: 19/306,800

(22) Filed: Aug. 21, 2025

Related U.S. Application Data
(60) Provisional application No. 63/686,489, filed on Aug. 23, 2024.
(60) Provisional application No. 63/692,563, filed on Sep. 9, 2024.
(60) Provisional application No. 63/720,649, filed on Nov. 14, 2024.
(60) Provisional application No. 63/729,637, filed on Dec. 9, 2024.

(51) Int. Cl. E04C 2/288; B32B 5/18; B32B 13/04; B32B 13/12; E04B 2/00; E04B 5/02; E04C 2/00

(52) U.S. Cl. CPC E04C 2/288; B32B 5/18; B32B 13/045; B32B 13/12; E04C 2/46; E04C 2/50; B32B 2250/03; B32B 2250/40; B32B 2266/0278; B32B 2266/04; B32B 2307/304; B32B 2307/7376; B32B 2607/00; E04C 2002/007; E04C 2002/008

(57) ABSTRACT

Exterior wall structures or roofing decks include an exterior wall or roof frame and lightweight composite sheathing panels fastened thereto by screws, other mechanical fasteners, and/or construction adhesive. Lightweight composite sheathing panels include a foam core and protective layers formed over and covering the foam core. The foam core may include extruded polystyrene (XPS), other polymer foam material, or inorganic foam material. The protective layers may include a fiber mesh reinforced cementitious composition, a thermoset polymer, or other rigid material. Joints between adjacent composite sheathing panels are sealed using sealing tape, polyurethane foam, and/or other sealant Lightweight composite sheathing panels can be fastened to studs or trusses suing screws, nails, adhesives, and other fasteners known in the art. The exterior wall structure or roofing deck is waterproof, fire-resistant, resists water damage, and facilitates application of finishes such as stucco, brick veneers, stone and masonry, shingles, roofing tiles, and metal cladding.

### CROSS-REFERENCE TO RELATED APPLICATIONS

This application claims the benefit of U.S. Provisional Application No. 63/729,637, filed Dec. 9, 2024, U.S. Provisional Application No. 63/720,649, filed Nov. 14, 2024, U.S. Provisional Application No. 63/692,563, filed Sep. 9, 2024, and U.S. Provisional Application No. 63/686,489, filed Aug. 23, 2024, which are incorporated by reference in their entirety.

### BACKGROUND

### Technical Field

This disclosure relates to exterior wall and roofing deck structures made using lightweight composite panels as exterior sheathing or other wall elements, such as to provide waterproofing, air barrier, load bearing, insulation, and/or shear strength.

### Related Technology

Houses and other buildings are typically constructed using wood or metal studs to form a three-dimensional frame, which is then covered by exterior wooden boards as sheathing to form exterior walls and roofing decks. Wooden sheathing used to make exterior walls and roofing decks can be any kind of plywood. The currently preferred and most common wooden sheathing used to make exterior walls and roofing decks are oriented strand board (“OSB”) panels because of their favorable cost and combination of materials properties. OSB panels are typically used to form exterior walls and roofing decks to which desired finishing elements can be attached, such as wall cladding, stucco, bricks, stone veneers, tiles, shingles, clay tiles, metal roof cladding, and the like.

FIGS. 1A and 1B illustrate a wooden OSB panel 100, including top and bottom surfaces 110 and side edges 120. FIG. 2A illustrates a framed house 200 that has been framed using wooden studs 210 to make the wall frames and roof trusses. Instead of wooden studs 210, the studs can include metal studs. The roof frame can alternatively comprise manufactured roof trusses, which are typically made from wooden beams joined together by metal fasteners. FIG. 2B illustrates a framed house 200 with OSB panels 100 attached to the studs (wooden and/or steel) to form outer walls and roofing decks.

OSB is a type of engineered wood, formed by adding adhesives and then compressing layers of wood strands (flakes) in specific orientations. OSB may have a rough and variegated surface with individual strips of around 2.5 cm×15 cm (1.0 by 5.9 inches) lying unevenly across each other. OSB can be produced in a variety of types and thicknesses. OSB is manufactured in wide mats from cross-oriented layers of thin, rectangular wooden strips compressed and bonded together with wax and synthetic resin adhesives. The adhesive resin types used include: urea-formaldehyde (for OSB type 1, nonstructural, non-waterproof); isocyanate-based glue (or PMDI poly-methylene diphenyl diisocyanate based) in inner regions with melamine-urea-formaldehyde or phenol formaldehyde resin glues at the surface (or OSB type 2, structural, water resistant on face); phenol formaldehyde resin throughout the OSB unit (for OSB types 3 and 4, structural, for use in damp and outside environments).

OSB is a material with favorable mechanical properties that make it particularly suitable for load-bearing applications in construction. It is now used more than plywood, reportedly making up 66% of the North American structural panel market. The most common uses are as sheathing in walls, flooring, and roof decks. For exterior wall applications, panels are available with a radiant-barrier layer laminated to one side, which cases installation and increases energy performance of the building envelope.

OSB and other wooden boards are not waterproof but prone to swelling, rotting, and developing mold and mildew if exposed to water over time. Hence, they are typically wrapped with a waterproof polymer membrane or other water-resistive barrier (WRB) to keep water from outside the building from contacting the OSB panels. The waterproof polymer membrane can also provide an air barrier that prevents unwanted air leakage. In addition, flashing, tape, and sealants can be used to cover joints to prevent water intrusion. After that, one or more layers of cladding or other materials are applied over the polymer membrane to form a finished outer wall. At least one of the outer layers must be mechanically attached or connected to OSB units to provide structure and hold them in place. This may require penetration of nails and screws through the waterproof polymer membrane, potentially compromising its integrity and providing a pathway for moisture intrusion.

Modified OSB panels, such as those use in the ZIP Wall Sheathing System (“ZIP System”) include core OSB panels to which an integrated water-resistive barrier (WRB) has been applied to the outer surface. This reportedly eliminates the need to wrap the modified OSB panels with a waterproof polymer membrane, saving time and labor costs. Because a building made using modified OSB panels is not wrapped with a polymer membrane, joints or seams between adjacent modified OSB panels must be sealed, such as with flexible waterproofing tape (e.g., flexible composite acrylic tape) to provide a waterproof barrier and prevent unwanted air leakage.

The ZIP System may also include an insulating foam layer (e.g., rigid polyisocyanurate foam) positioned between the modified OSB panels and the underlying structural wall elements (e.g., wood or metal studs) to which the modified OSB panels are fastened. This is known as the ZIP System Insulated R-Sheathing. The thickness of the foam layer can be selected to provide a desired R-value to the outer walls (which varies between R-3 and R-12, depending on the insulating foam thickness).

FIG. 3A illustrates a modified OSB panel 300 used in the ZIP System, which includes an interior structural OSB layer 310, a water-resistive barrier layer 320 on an outer surface of the OSB layer 310, and an insulating foam layer 330 on an inner surface of the OSB layer 310. FIG. 3B illustrates a structural wall 340 that includes a wall frame 342 comprising studs 344 and a plurality of modified OSB panels 300 attached to the wall frame 342. Strips of flexible tape 346 are used to seal joints or seams (on the wall surface and corners) between adjacent modified OSB panels 300.

Modified OSB panels can nonetheless suffer from problems similar to conventional OSB panels, including having relatively high weight, making them unwieldy, difficult to install, and potentially dangerous, such as when workers must attach heavy OSB panels to form outer walls of upper floors or roofing decks high above the ground, typically using scaffolding. Hoisting and placing heavy OSB panels can cause a worker to lose their balance and fall. Moreover, if the OSB panel is dropped, it can cause significant damage to underlying equipment and/or cause injury or death to a person below.

Moreover, while exterior surfaces of OSB panels can be made water-resistant, such as by wrapping traditional OSB panels with a waterproof polymer membrane or providing modified OSB units with a WRB (e.g., Zip System OSB panels), the main structure of all OSB panels is still made of wood and subject to water damage in the event water is able to penetrate through or work its way around exterior waterproofing barriers. For example, it may be necessary to use nails or screws to attach one or more finishing layers over polymer wrapped or modified OSB panels, which penetrate through the WRB. Any possibility of water intrusion leaves modified OSB panels vulnerable to water damage, such as swelling, rotting, and developing mold and mildew, similar to traditional OSB panels.

Another issue is that both conventional and modified OSB panels are flammable and emit toxic gases when ignited, such as during house fire. Moreover, burning OSB panels can emit embers that can quickly spread and ignite other fires, such as those which devastated entire neighborhoods near Los Angeles, California, in January 2025.

Other structural panels include drywall used for interior walls and ceilings in buildings. A drywall panel typically consists of a layer of gypsum plaster sandwiched between two layers of paper. Gypsum plaster is made from calcium sulfate hemihydrate (or plaster of Paris) and water and mixed with fiber (typically paper and/or glass fiber), plasticizer, foaming agent, finely ground gypsum crystal as accelerator, EDTA, starch or other chelate as a retarder, and various additives that can increase mildew and fire resistance, lower water absorption (wax emulsion or silanes), and reduce creep (tartaric or boric acid). The board is then formed by sandwiching a core of the wet plaster mixture between two sheets of heavy paper or fiberglass mats. When the core sets, it is dried in a drying chamber, and the sandwich becomes rigid and strong enough for use as a building material.

While suitable for walls that are not exposed to water, drywall is not suitable for applications exposed to water and high humidity environments. Drywall is highly vulnerable to moisture due to the inherent properties of the materials that constitute it: gypsum, paper, and organic additives and binders. Gypsum will soften with exposure to moisture and turn into a gooey paste with prolonged immersion, such as during a flood or even in a bathroom when exposed to excessive water. Following water damage, drywall will likely need to be removed and replaced. Furthermore, the paper facings and organic additives mixed with the gypsum can be a breeding ground for mold. Gypsum boards with fiberglass mats are often used for exterior sheathing and sometimes referred to as “glass-mat gypsum”. Although they offer some moisture and mold resistance they still have a gypsum core and are therefore susceptible to moisture damage therefore requiring an additional water-resistant barrier (WRB).

Accordingly, there remains a need for exterior and interior structural panels and wall and roofing systems that are waterproof, provide high strength, have sufficient shear strength to be used as wall sheathing, are fire resistant, and yet are lightweight and easy to handle and install.

### SUMMARY

Disclosed are methods and systems for constructing exterior wall structures and roofing decks using lightweight composite panels as sheathing and other structural elements. Exterior wall structures and roofing decks made using lightweight composite sheathing panels solve problems with exterior walls and roofing decks that comprise OSB or other plywood sheathing, including greatly reduced weight, increased case of handling and safety during installation, resistance to water damage, including resistance to swelling, rotting, mold and mildew, and which provide a level of fire-resistance.

The lightweight composite sheathing panels comprise a lightweight foam core sandwiched between first and second protective layers selected from a fiber mesh reinforced cementitious composition, cured thermoset resin, or other rigid material. The lightweight composite sheathing panels can be cut, drilled, and screwed onto structural elements of buildings, such as wall frames comprising wooden or metal studs, roof frames comprising boards, studs, or trusses, floor joists, concrete floors, foundations, and the like.

In some embodiments, one or more protective layers of the lightweight composite sheathing panels comprise a fiber mesh reinforced cementitious composition. Protective layers made from fiber mesh reinforced cementitious composition can be “thin” (e.g., typically less than about 3 mm, less than about 2.5 mm, less than about 2 mm, or less than about 1.5 mm, such as about 1 mm, in cross-sectional thickness), are lightweight yet waterproof and have high structural strength (i.e., high tensile and flexural strength and high toughness). The fiber mesh component is typically fiberglass fiber or filament mesh but can be made of other strong fibers or filaments, such as carbon fibers or filaments.

In addition to, or instead of, a fiber mesh reinforced cementitious layer, one or both protective layers of the lightweight composite sheathing panels may comprise other materials in addition to or instead of the fiber mesh reinforced cementitious composition. Examples include one or more of rigid magnesium oxide material, water-resistant polymer, or a composite material comprising a resin or polymer with embedded fibers, fiber mesh, fabric, woven, scrim, felt, or non-woven. The material forming the fibers, fiber mesh, fabric, scrim, felt, or non-woven can be selected from plant fibers, polymer fibers, and inorganic fibers (e.g., basalt, rock wool, and the like). The resin or polymer may comprise a thermoplastic or thermoset material, such as UV-cured resins, polypropylene, polycarbonate, polyethylene terephthalate, polystyrene, acrylate, methacrylate, polyurea, polyaspartic, or epoxy. Protective layers of thermoset polymer can be slightly thicker than fiber mesh reinforced cementitious layers, such as between about 1-5 mm or about 2-3 mm.

The lightweight foam core is typically made from extruded polystyrene foam (XPS) but can alternately comprise expanded polystyrene foam (EPS), polyisocyanurate foam, polyurethane (PUR) foam, phenolic polymers (e.g., phenol-formaldehyde) melamine polymers (e.g., melamine-formaldehyde), and/or other thermoplastic and thermoset polymers known in the art that can be formed into rigid or semi-rigid foam layers.

Alternatively, the foam core may comprise an inorganic foam materials, such as a refractory foam material, to provide additional fire-resistance. Examples include silica gel, aerogel, silicate foams, urea-silicate foam, SiOC/SiC, ceramic foams, refractory foams, and the like. The inorganic foam core can resist melting even when exposed to fire or intense heat in order for the lightweight composite sheathing panel to maintain its structural integrity.

The lightweight composite sheathing panels are substantially lighter than OSB or other plywood units, are waterproof, have high structural strength (i.e., high tensile and flexural strength and high toughness), can function as a shear wall of an exterior wall structure or roofing deck, and can support relatively heavy loads, such as multiple layers of stucco finish, brick veneers, stone and masonry, shingles, clay tiles, metal roofing elements, light fixtures, and other fixtures using nails, other hangers, construction adhesive, or other wall attachment systems.

In some embodiments, a method of constructing an exterior wall structure or roofing deck comprises: (1) forming or providing an exterior wall or roof frame comprising a plurality of studs or other structural elements; (2) fastening a plurality of lightweight composite sheathing panels to an exterior side of the exterior wall or roof frame, the lightweight composite sheathing panels each comprising: (a) a foam core (e.g., polymer or inorganic foam) having a first surface, a second surface opposite the first surface, a first edge forming a perimeter of the first surface, a second edge forming a perimeter of the second surface, and side surfaces extending between the first and second edges; (b) a first protective layer (e.g., first fiber mesh reinforced cementitious layer, thermoset polymer, or other rigid material) formed over and covering at least a portion of the first surface of the foam core; and (c) a second protective layer (e.g., second fiber mesh reinforced cementitious layer, thermoset polymer, or other rigid material) formed over and covering at least a portion of the second surface of the foam core, (d) wherein the lightweight composite sheathing panels are positioned so that one protective layer faces toward, and the other protective layer faces away from, the exterior side of the exterior wall or roof frame; and (4) sealing one or more joints or seams between adjacent lightweight composite sheathing panels.

In some embodiments, an exterior wall structure or roofing deck comprises: (1) an exterior wall or roof frame comprising a plurality of studs or other structural elements; (2) a plurality of lightweight composite sheathing panels fastened to an exterior side of the exterior wall or roof frame, the lightweight composite sheathing panels each comprising: (a) a foam core (e.g., polymer or inorganic foam) having a first surface, a second surface opposite the first surface, a first edge forming a perimeter of the first surface, a second edge forming a perimeter of the second surface, and side surfaces extending between the first and second edges; (b) a first protective layer (e.g., first fiber mesh reinforced cementitious layer, thermoset polymer, or other rigid material) formed over and covering at least a portion of the first surface of the foam core; and (c) a second protective layer (e.g., second fiber mesh reinforced cementitious layer, thermoset polymer, or other rigid material) formed over and covering at least a portion of the second surface of the foam core, (d) wherein the lightweight composite sheathing panels are positioned so that one protective layer faces toward, and the other protective layer faces away from, the exterior side of the exterior wall or roof frame; and (4) at least one of tape, polyurethane, or other sealant that seals one or more joints or seams between adjacent lightweight composite sheathing panels.

The lightweight composite sheathing panels can be fastened to an exterior side of the exterior wall or roof frame to form an exterior wall structure or roofing deck using mechanical fasteners and adhesives known in the art, such as wood screws, sheet metal screws, nails, rivets, and construction adhesive. Mechanical fasteners are advantageously corrosion resistant. Strips of tape can be used as a template to ensure proper placement of screws or other mechanical fasteners when fastening lightweight composite sheathing panels to studs or other structural elements of an exterior wall or roof frame. To prevent screws from tearing through the exterior fiber mesh reinforced cementitious (or other protective) layer, screws can be used with enlarged washers or pan head screws or screws with integrated washers having high surface area to distribute the pressure or load over a high surface area of the lightweight composite sheathing panels. Specialized washers with penetrating prongs can be used to limit rotation and penetration, preventing damage to the lightweight composite sheathing panels. Rectangular washers with multiple prongs on either side of the screw can be used to tie adjacent lightweight composite sheathing panels together.

In some embodiments, the fiber mesh reinforced cementitious (or other protective) layers of the lightweight composite sheathing panels can have a grid pattern or other discontinuity that can facilitate adhesion of cementitious materials, stucco, adhesives, paint, or other coatings to exposed surfaces of the lightweight composite sheathing panels. For example, one or more stucco layers can directly adhere to the fiber mesh reinforced cementitious (or other protective) layer without the need for wire mesh, scratch coat, and brown coat used in conventional stucco systems. Nevertheless, it may be desirable to apply a layer of thin set mortar to cover screws, sealants, holes, or other discontinuities prior to applying a finished stucco layer (which can be cementitious or acrylic bases).

The textured surface provided by the fiber mesh reinforced cementitious layers can also facilitate adhesion of lightweight composite sheathing panels to the exterior wall or roof frame. In this embodiment, an appropriate adhesive, such as construction adhesive, can be used to adhere the lightweight composite sheathing panels to the exterior wall or roof frame, either in addition to or instead of screws or other mechanical fasteners. The use of an adhesive provides a much more continuous bond interface between lightweight composite sheathing panels and studs or other structural elements, thereby distributing the load more evenly and improving shear strength of the wall or roof structure. Screws used by themselves may create discrete attachment points that might theoretically become potential weak points under high shear stresses. The use of adhesive attachment in addition to or instead of screws eliminates these discrete attachment points, creating a more solid and continuous bond that can better resist lateral forces. Screws, mechanical fasteners, and adhesives are examples of means for fastening lightweight composite sheathing panels to studs or other structural elements of an exterior wall or roof frame.

Additional features and advantages will be set forth in part in the description that follows, and in part will be obvious from the description, or may be learned by practice of the embodiments disclosed herein. It is to be understood that both the foregoing brief summary and the following detailed description are exemplary and not restrictive of the embodiments disclosed herein or as claimed

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIGS. 1A and 1B illustrate a conventional oriented strand board (OSB) panel;

FIG. 2A illustrates a framed house with exposed studs forming exterior wall frames and roof trusses prior to attachment of OSB panels;

FIG. 2B illustrates a framed house with OSB panels attached to the exterior wall frames and roof trusses of the framed house;

FIG. 3A illustrates a modified OSB panel that includes an OSB layer, a water-resistive barrier (WRB) layer on an outer surface, and optionally an insulating layer on an inner surface;

FIG. 3B illustrates a wall frame to which modified OSB panels have been attached, with joints or seams between adjacent modified OSB panels sealed using tape;

FIG. 4A is a side perspective view that illustrates examples of differently-sized lightweight composite sheathing panels that can be used to form exterior wall structures or roofing decks;

FIG. 4B is a top perspective view that illustrates the differently sized lightweight composite sheathing panels of FIG. 4A;

FIG. 5 is an exploded diagram that schematically illustrates the layered structure of the lightweight composite sheathing panels of FIGS. 4A and 4B;

FIGS. 6A and 6B schematically illustrate an exterior wall structure or roofing deck comprising a lightweight composite sheathing panel attached to an exterior wall or roof frame and illustrative positioning of screws or other mechanical fasteners used to attach the lightweight composite sheathing panel to wood or metal studs;

FIGS. 7A and 7B schematically illustrates an embodiment in which a lightweight composite sheathing panel forming an exterior wall structure or roofing deck can include other finishing layers or features;

FIG. 8 schematically illustrates another example of a lightweight composite sheathing panel for use in forming an exterior wall structure or roofing deck, with example positioning of screws and construction adhesive used to attach the lightweight composite sheathing panel to studs of an exterior wall or roof frame;

FIG. 9A is an exploded view of an example complete wall system that includes a lightweight composite sheathing panel attached to an exterior side of a wall or roof frame, insulation between studs of the wall or roof frame, and an interior wall panel attached to an interior side of the wall or roof frame;

FIG. 9B is a cross-sectional view of the complete wall system of FIG. 9A in assembled form;

FIG. 10 illustrates mesh tape used as a template for proper placement of screws or other mechanical fasteners when fastening lightweight composite sheathing panels to studs or other structural elements of an exterior wall or roof frame;

FIG. 11 illustrates a lightweight composite sheathing panel with holes caused by screws with heads that penetrated through the exterior fiber mesh reinforced cementitious layer and a screw with a washer that did not penetrate through the cementitious layer; and

FIG. 12 illustrates an embodiment of a specialized washer with multiple prongs designed to penetrate at least partially through and become embedded within the lightweight composite sheathing panel; and

FIGS. 13A-13C illustrate another embodiment of a specialized washer with multiple prongs designed to penetrate at least partially through and become embedded within the lightweight composite sheathing panel.

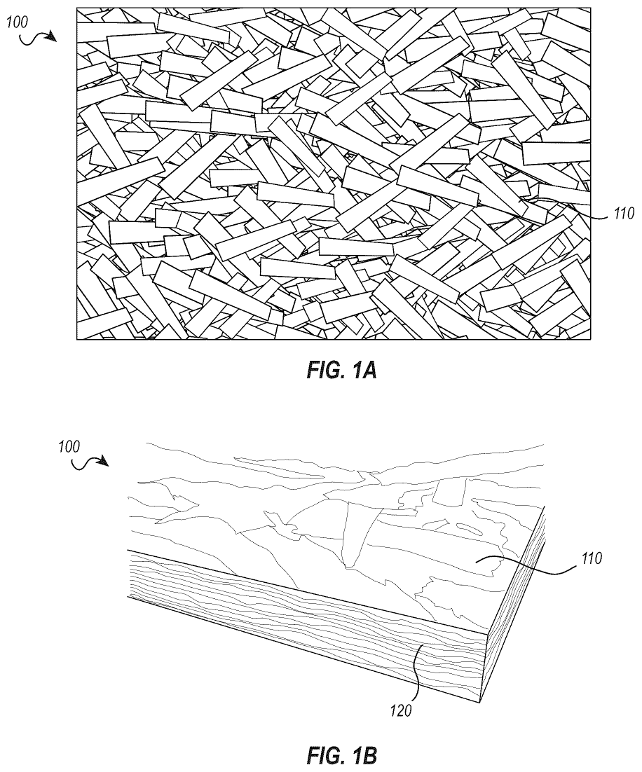

### DETAILED DESCRIPTION

### I. Overview

Disclosed are exterior wall structures and roofing decks made using lightweight composite sheathing panels, which are attached to an exterior side of an exterior wall or roof frame that includes a plurality of studs, trusses, or other structural elements. The exterior wall structures or roofing decks solve problems with exterior walls or roofing decks that comprise OSB panels or other plywood products, including greatly reduced weight, increased case of handling and safety during installation, better resistance to water damage, including being resistant to swelling, rotting, mold and mildew, and better fire-resistance.

The lightweight composite sheathing panels can replace conventional or modified OSB units to yield superior exterior wall structures and roofing decks. They include a strong, yet lightweight, foam core sandwiched between relatively thin fiber mesh reinforced cementitious (or other protective) layers. As a result, the lightweight composite sheathing panels are strong, can function as a shear wall of an exterior wall structure or roofing deck, and can support relatively heavy loads, such as multiple layers of stucco finish, brick veneers, stone and masonry, wall tiles, shingles, clay roofing tiles, metal roof cladding, light fixtures, and other fixtures using nails, other hangers, construction adhesive, or other wall attachment systems. The composite sheathing panels are waterproof and lightweight, yet have high structural strength (i.e., high tensile and flexural strength and high toughness). They can function as a shear wall but are much lighter than OSB or other plywood panels. The fiber mesh reinforced cementitious composition can form a textured surface or grid pattern, which can facilitate application of adhesives, stucco, brick veneers, stone and masonry, tiles, stone veneers, roofing elements, and other structural and finishing elements. The lightweight composite sheathing panels can be cut, drilled, and screwed, nailed, riveted, fastened and/or glued onto structural elements of buildings, such as wall studs.

### II. Lightweight Composite Sheathing Panels

Lightweight composite sheathing panels disclosed herein can be used to make exterior wall structures and roofing decks. They comprise a strong, yet lightweight, foam core and a protective layer selected from fiber reinforced cementitious compositions, thermoset polymer, or magnesium oxide, on each side of the foam core. As a result, the lightweight composite sheathing panels are strong and can support relatively heavy loads, such as decorative or structural features attached to exterior wall structures or roofing decks. Examples include, but are not limited to, one or more layers of stucco (underlying and finished layers), brick veneers, stone and masonry, wall tiles, stone veneers, shingles, clay roofing tiles, metal roof cladding, light fixtures, and other fixtures using adhesives, screws, nails, rivets, hangers, and other wall attachment systems.

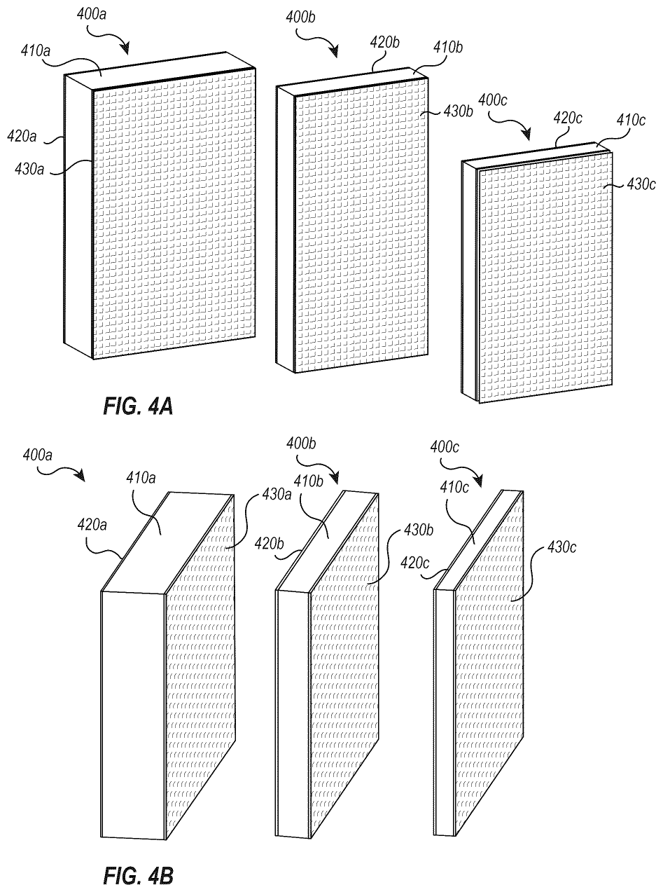

FIGS. 4A and 4B illustrate examples of lightweight composite sheathing panels 400a, 400b, 400c of varying cross-sectional thickness that can be used as is or modified with other features for a specific purpose. FIGS. 4A and 4B show the layered structure of the lightweight composite sheathing panels 400a, 400b, 400c, including strong, lightweight, and moisture-resistant extruded polystyrene (XPS) foam cores 410a, 410b, 410c sandwiched between first fiber mesh reinforced cementitious layers 420a, 420b, 420c and second fiber mesh reinforced cementitious layers 430a, 430b, 430c. As discussed below, in other embodiments the foam core 410 may comprise other polymer or inorganic foam materials, and one or both protective layers may comprise a thermoset polymer or other rigid protective material.

The cross-sectional thickness of lightweight composite sheathing panels 400a, 400b, 400c can be selected based on a combination of desired properties for their intended use, such as strength, insulation, spacing between wall elements, and the like. As illustrated in FIGS. 4A and 4B, the cross-sectional thicknesses of the lightweight composite sheathing panels 400a, 400b, 400c varies mostly or entirely depending on the cross-sectional thickness of the foam cores 410a, 410b, 410c. Although not shown, when lightweight composite sheathing panels 400 of greater cross-sectional thickness are desired, it may be desirable to increase the thickness of the fiber mesh reinforced cementitious layers 420, 430 (e.g., to account for possible strength reduction caused by including a foam core 410 of greater cross sectional thickness).

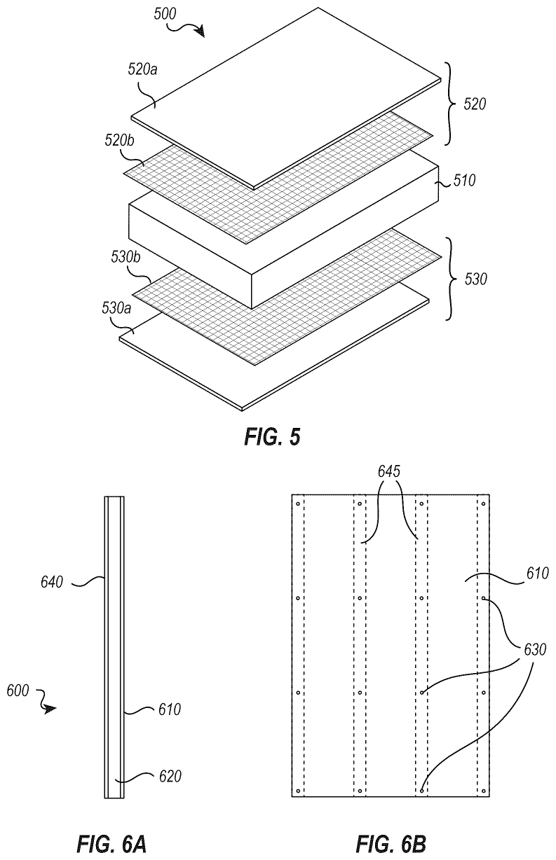

FIG. 5 is in an exploded view that schematically illustrates the layered structure of an example lightweight composite sheathing panel 500, which is similar or identical to the lightweight composite sheathing panels 400a, 400b, 400c of FIGS. 4A and 4B. The foam core 510 can be a lightweight polymer foam made from closed cell extruded polystyrene (XPS), is lightweight, rigid, highly water-resistant, and thermally insulating, and includes two outer surfaces or faces. In some embodiments, the foam core 510 may have a density of about 30-45 kg/m³ and a compressive strength of about 250-400 kPa.

Alternatively, the foam cores 410, 510 discussed above can be made from a different polymer foam material, such as, but not limited to, expanded polystyrene foam (EPS), polyisocyanurate foam, polyurethane (PUR) foam, phenolic polymer (e.g., phenol-formaldehyde) foam, melamine polymer (e.g., melamine-formaldehyde) foam, and/or other thermoplastic or thermoset polymer known in the art that can be formed into rigid or semi-rigid foam layers. An advantage of thermoset polymer foam materials is they are generally more fire- and heat-resistant than thermoplastic polymers, with thermoset phenolic polymers in particular providing a high level of fire and heat resistance.

The properties of various polymers that can be used to make foam core layers 410, 510 are set forth in Tables 1-3.

TABLE 1

| Property | XPS/EPS | Phenolic | |
|---|---|---|---|
| Material Type | Thermoplastic | Thermoset (phenol- | |
| | polystyrene | formaldehyde) | |
| Thermal Conductivity (W/m · K) | 0.028-0.033 | 0.018-0.022 | |
| R-Value per inch | ~5.0 | 6.5-7.2 | |
| Fire Resistance | Poor - melts, drips | Excellent - chars, low | |
| | | smoke | |
| Flame Spread (ASTM E84) (W/O Facer | 75-200 | <25 (Class A) | |
| Smoke Development (W/O Facer) | >450 (often) | <50 | |
| Thermal Stability | ~93° C. (melts) | 150-175° | C. |
| Water Resistance | Excellent | Good (closed-cell) | |
| Compressive Strength | 200-300 kPa | 100-150 | kPa |

| | | |
|---|---|---|
| Flexural Strength | Flexible, good | Brittle |
| Recyclability | Yes (thermoplastic) | No |
| Weight (kg/m³) | 25-35 | 35-50 |
| Cost | Low-Moderate | High |

TABLE 2

| Property | Melamine | PUR | |
|---|---|---|---|
| Material Type | Thermoset (melamine- | Thermoset (polyol + | |
| | formaldehyde) | isocyanate) | |
| Thermal Conductivity (W/m · K) | 0.032-0.036 | 0.020-0.025 | |
| R-Value per inch | ~4.1-4.5 | ~6.0-6.5 | |
| Fire Resistance | Excellent - non- | Poor - needs FR | |
| | melting, self- | additives | |
| | extinguishing | | |
| Flame Spread (ASTM E84) (W/O Facer | <25 (Class A) | Varies (often >25) | |
| Smoke Development (W/O Facer) | Very low | High | |
| Thermal Stability | ~240° C. | ~100-120° | C. |
| Water Resistance | Poor unless sealed | Good | |
| Compressive Strength | Low | 150-300 | kPa |

| | | |
|---|---|---|
| Flexural Strength | Very brittle | Strong |
| Recyclability | Limited | No |
| Weight (kg/m³) | 7-12 | 30-45 |
| Cost | High | Moderate |

TABLE 3

| Property | Polyiso | |
|---|---|---|
| Material Type | Thermoset (polyisocyanurate) | |
| Thermal Conductivity (W/m · K) | 0.020-0.023 | |
| R-Value per inch | ~6.0-6.5 | |
| Fire Resistance | Good - chars, often Class A | |
| | with facer | |
| Flame Spread (ASTM E84) (W/O Facer | <25 (Class A with facer) | |
| Smoke Development (W/O Facer) | <150 | |
| Thermal Stability | ~150° | C. |
| Water Resistance | Fair (can degrade if | |
| | unprotected) | |
| Compressive Strength | 140-200 | kPa |

| | |
|---|---|
| Flexural Strength | Moderate |
| Recyclability | Rarely recycled |
| Weight (kg/m³) | 30-42 |
| Cost | Moderate-High |

With reference to FIG. 5, formed over first and second outer surfaces of the foam core 510 are first and second layers of fiber (e.g., fiberglass) mesh 520b, 530b, respectively, which become embedded within respective first and second layers of fresh cementitious composition applied over the fiber mesh layers 520b, 530b, which harden or cure to form first and second cementitious layers 520a, 530a. Together, the hardened cementitious layers 520a, 530a and embedded fiberglass mesh layers 520b, 530b form first and second fiber mesh reinforced cementitious layers 520, 530, which adhere to the foam core 510 to form a strong but lightweight composite sheathing panel structure. The fiber mesh layers 520b, 530b can alternatively include other fibers or filaments, such as carbon fibers or filaments.

The lightweight foam core is typically made from extruded polystyrene foam (XPS), but can alternately comprise expanded polystyrene foam (EPS), polyisocyanurate foam, polyurethane (PUR) foam, phenolic polymer (e.g., phenol-formaldehyde) foam, melamine polymer (e.g., melamine-formaldehyde) foam, and/or other thermoplastic or thermoset polymer known in the art that can be formed into rigid or semi-rigid foam layers. The lightweight foam core can be made of closed cell polystyrene foam to provide a water-resistant barrier (e.g., 100% waterproof).

Alternatively, the foam core may comprise an inorganic foam, such as a refractory foam material, to provide additional fire-resistance. Examples include silica gel, aerogel, silicate foams, urea-silicate foam, SiOC/SiC, ceramic foams, refractory foams, and the like. The inorganic foam core can resist melting even when exposed to fire or intense heat in order for the lightweight composite panel to maintain its structural integrity.

In some embodiments, the lightweight composite sheathing panels are manufactured by applying a fiber (e.g., fiberglass) mesh and fresh cementitious composition onto first and second surfaces of a rigid polymer (e.g., XPS) or inorganic foam core and causing or allowing the applied cementitious composition to harden. The fiber mesh becomes embedded in the hardened cementitious layer to enhance strength, increase toughness, and prevent cracking of the hardened cementitious layer. Alternatively, at least one of the hardened cementitious layers can be replaced or augmented with a cured polymer layer.

The layers of fiber mesh reinforced cementitious composition are generally “thin” (e.g., typically less than about 3 mm, less than about 2.5 mm, less than about 2 mm, or less than about 1.5 mm, such as about 1 mm, or between about 0.5-3 mm, about 0.75-2.5 mm, or about 1-2 mm in cross-sectional thickness). The fiber mesh reinforced cementitious layers can be very lightweight yet waterproof and have high structural strength (i.e., high tensile and flexural strength and high toughness). The fiber mesh component is typically fiberglass fiber or glass filament mesh, but can be made of other strong fibers or filaments, such as carbon fibers or filaments. In some embodiments, fiberglass mesh is formed of an alkali-resistant material and may have nominal mesh size of 4×4 mm with a strand diameter of about 0.5-1.0 mm.

In some embodiments, the fresh cementitious composition comprises mixture products of water, hydraulic cement, silicon dioxide powder, calcium oxide, iron oxide, plaster of Paris (gypsum hemihydrate), water-reducing agent, defoamer, styrene, and acrylic acid. The fresh cementitious composition may optionally include supplementary cementitious materials (SCMs), such as ground granulated blast furnace slag (GGBFS), fly ash, natural pozzolan, silica fume, microsilica, metakaolin, ground glass, calcined clay, finely ground quartz, limestone powder, and the like. The cementitious composition may include other components, such as natural hydraulic lime, calcium silicate, and/or expanded glass, which can increase fire and heat resistance.

In a more particular embodiment, the cementitious composition applied to the outer surfaces of the foam core to form fiber mesh reinforced cementitious layers of the lightweight composite sheathing panels can be formed by mixing together the following components (expressed in weight percent) to form a fresh flowable cementitious composition, which is applied to the foam core surfaces, together with fiber mesh, and then allowed to harden or cure:

| | |
|---|---|
| Hydraulic cement | 30-50% |
| Silicon dioxide | 40-60% |
| Calcium oxide | 2-5% |
| Iron oxide | 0.2-1% |
| Gypsum hemihydrate | 3-8% |
| Water-reducing agent | 0.2-0.6% |
| Defoamer | 0.2-0.6% |
| Styrene | 1-2% |
| Acrylic acid | 1-2% |
| Water | (16-20%, preferably 18.4% |
| | dry ingredients above) |

The hydraulic cement typically includes Portland cement clinker interground with gypsum for set control, but may also include other interground minerals, such as limestone filler (e.g., 5-10% by weight of the hydraulic cement), and optionally one or more supplementary cementitious materials (SCMs), such as ground granulated blast furnace slag (GGBFS), fly ash, natural pozzolan, silica fume, microsilica, metakaolin, ground glass, calcined clay, finely ground quartz, and the like. The silicon dioxide can be 150 mesh ground quartz sand. The water reducer can be a low-range water reducer, such as a compound of carboxylic acid grafted multi-polymer and other effective additives. The defoamer can reduce the surface tension of water, solution, suspension, etc., prevent the formation of foam, or reduce or eliminate the original foam. The main component of the defoamer can be polydimethylsiloxane (Me₃SiO(Me₂SiO)nSiMe₃) (Me=methyl). In the case where very fine SCMs (e.g., silica fume, microsilica, or metakaolin), it may be desirable to use a high range water reducer (e.g., polycarboxylate ether) to obtain good flow. The styrene and acrylic acid components, which may be a copolymer, can form a chemical bond to the extruded polystyrene foam core, in addition to the physical bond.

The components of the cementitious composition can be mixed by high-performance mixing equipment through precise batching, and then fed into a mixing barrel in sequence for high-speed dispersion and mixing, thus yielding a fresh cementitious mixture. The fresh cementitious mixture is blended in a tank to make it into liquid or plastic form. The liquid cementitious mixture is then pumped into a machine variously called a “waterfall machine,” commonly known as a “curtain coater” or enrobing “coater/machine”, which has flow control of the liquid cementitious mixture and which will apply the liquid cementitious mixture onto surfaces of an extruded polystyrene foam sheet or other material to be coated. The liquid cementitious mixture is applied like a waterfall or curtain through a blade applicator to evenly apply it to the polymer foam surfaces or other surface to be coated. The product is then cured and left to stand for approximately 7 days as usual practice. However, if ambient conditions are dry and hot, the curing period could be shortened to approximately 3-4 days.

In general, the hardened fiber mesh reinforced cementitious composition can adhere and bond strongly to the polymer or inorganic foam core to form a strong lightweight composite panel structure that does not delaminate. The bond between the cementitious layers and the foam layer is likely a combination of physical and chemical interactions. When applied to the polymer or inorganic foam layer, the liquid cementitious composition can penetrate into surface pores of the foam layer, which upon hardening of the cementitious composition, forms a strong mechanical bond. This bond can be further enhanced through the inclusion of very fine pozzolans, such as silica fume, microsilica, or metakaolin on the cementitious composition, which creates a very high strength cementitious layer and are able to fill very small micropores. The polymer components of the cementitious composition may also interact with components of the foam layer to form a type of chemical bond between the cementitious layers and the foam (e.g., polymer) layer. Regardless of how bonding occurs, it is demonstrably very strong and does not delaminate during specified use. Curable resins also adhere and bond strongly to the foam core.

In some embodiments, when manufacturing the lightweight composite panel structure, the fiberglass mesh is first laid down on a polymer (e.g., extruded polystyrene) or inorganic foam sheet. A transportation belt then transports the foam sheet with the fiberglass mesh through the waterfall machine (commonly known as a “curtain coater” or enrobing “coater/machine”), which causes the liquid cementitious mixture to flow down like a waterfall or curtain, with control of the liquid cementitious mixture flow, onto the foam sheet or other substrate. In this way, the fiberglass mesh becomes embedded in the liquid cementitious mixture and essentially floats in the middle of the cementitious mixture. In other words, a portion of the liquid cementitious mixture will be positioned between the fiberglass mesh and the foam sheet in order to directly adhere to the foam sheet, and another portion of the liquid cementitious mixture will cover and encapsulate the fiber mesh to form the top surface of the lightweight composite panel structure. The result is a layered composite structure, with an interior polymer or inorganic foam sheet, an underlying layer of cementitious composition in direct contact with the foam sheet, a fiberglass mesh in the middle, and a top layer of cementitious composition covering the fiberglass mesh.

In addition to, or instead of, a fiber mesh reinformed cementitious layer, one or both protective layers of the lightweight composite panel may comprise other materials in addition to or instead of the cementitious composition. Examples include one or more of rigid magnesium oxide material, water-resistant polymer, or a composite material comprising a resin or polymer with embedded fibers, fiber mesh, fabric, scrim, felt, or non-woven. The material forming the fibers, fiber mesh, fabric, scrim, felt, or non-woven can be selected from plant fibers, polymer fibers, and inorganic fibers (e.g., basalt, rock wool, and the like). The resin or polymer may comprise a thermoplastic or thermoset material, such as UV-cured resins, polypropylene, polycarbonate, polyethylene terephthalate, polystyrene, acrylate, methacrylate, polyurea, polyaspartic, or epoxy. Protective layers of thermoset polymer can be slightly thicker than fiber mesh reinforced cementitious layers, such as between about 1-5 mm or about 2-3 mm.

Polyurea is a type of elastomer that is derived from the reaction product of an isocyanate component and an amine component. The isocyanate can be aromatic or aliphatic in nature. It can be monomer, polymer, or any variant reaction of isocyanates, quasi-prepolymer or a prepolymer. The prepolymer, or quasi-prepolymer, can be made of an amine-terminated polymer resin, or a hydroxyl-terminated polymer resin. The resin blend can include amine-terminated polymer resins and/or amine-terminated chain extenders. The resin blend may also contain additives or non-primary components, such as pigments pre-dispersed in a polyol carrier. Normally, the resin blend does not contain a catalyst. This is because the reaction between an isocyanate and amine is extremely fast and hence does not need catalysis.

The chemical structure of polyurea is as follows:

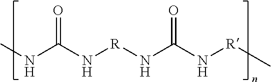

In a polyurea, alternating monomer units of isocyanates and amines react with each other to form urea linkages, as shown below.

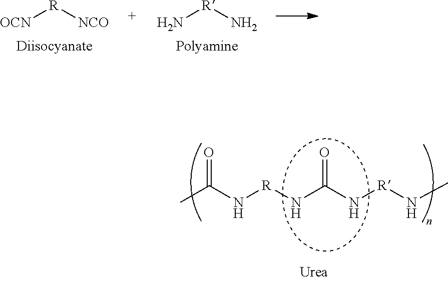

Polyaspartic resin is a solvent-free, aliphatic amine coating material based on aspartic acid, polyaspartic acid, or polyaspartic ester, which reacts with an isocyanate to create extremely durable protective coatings with rapid cure times, excellent abrasion resistance. An example of a curable polyaspartic resin has the following reactants and final cured polymer structure:

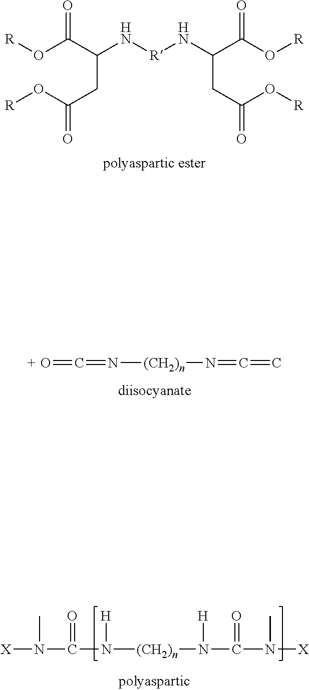

The curable resin can be applied by spray coating while in a flowable state to one or both surfaces of the foam core and allowing it to cure and form a solid protective layer. Multiple parts of the curable resin can be mixed just prior to entering or within the nozzle used to spray coat the foam core. Where it is desired to incorporate a fiberglass mesh sheet in the polymer layer, an initial coating of curable resin can be applied to the foam core, followed by applying the fiberglass mesh sheet over the resin, followed by applying a final coating of the curable resin.

In some embodiments, the outlines of the fiberglass mesh embedded within the hardened cementitious or cured resin layer can be visible and form a grid-like texture that improves adhesion of structural and/or decorative materials thereto, such as cementitious coatings, adhesives, stucco, paint, brick veneers, stone and masonry, stone veneers, shingles, clay tiles, metal cladding, and the like. For example, one or more stucco layers can directly adhere to the fiber mesh reinforced cementitious layer without the need for wire mesh, scratch coat, and brown coat used in conventional stucco systems. Nevertheless, it may be desirable to apply a layer of thin set mortar to cover screws, sealants, holes, or other discontinuities in the lightweight composite panels prior to applying a finished stucco layer (which can be cementitious or acrylic bases).

Alternatively, traditional methods of systems for applying stucco, brick veneers, stone and masonry, stone, or other external decorative features can be applied over the exterior wall structures or roofing decks disclosed herein. For example, a water drainage plane can be attached to the lightweight composite sheathing panels, followed by the usual layers used to make traditional stucco or thin brink systems, including, for example, wire mesh or lath, a cementitious scratch coat, a cementitious brown coat, and a finished stucco layer, which can be cement-based or acrylic-based stucco.

The textured surface provided by the fiber mesh reinforced cementitious layer can also facilitate adhesion of lightweight composite sheathing panels to the exterior wall or roof frame. In this embodiment, an appropriate adhesive, such as construction adhesive, can be used to adhere the lightweight composite sheathing panels to the exterior wall or roof frame, either in addition to or instead of screws or other mechanical fasteners. The use of an adhesive provides a much more continuous bond interface between lightweight composite sheathing panels and studs or other structural elements, thereby distributing the load more evenly and improving shear strength. The use of adhesive attachment in addition to or instead of screws can eliminate discrete attachment points, creating a more solid and continuous bond that can better resist lateral forces and improve shear strength of the exterior wall structure or roofing deck.

The lightweight composite sheathing panels are typically rectangular in shape, with a constant cross sectional thickness. The lightweight composite sheathing panels can have multiple uses, including for interior walls that are exposed to moisture, providing a substrate to which tiles, stones, or other surface treatments can be applied, other interior walls (e.g., plaster coated composite panels), exterior sheathing that complements or replaces OSB panels, as a backer board for stucco, brick veneers, stone and masonry, natural or manufactured stone, or other finishes, roofing boards that function as underlayment for shingles, roofing tiles, metal roofing sheets, wood shakes, and the like, floor underlayment, ceiling panels, and shaft liners. The lightweight composite sheathing panels can be modified for specialized uses, such as by applying a decoupling layer, drainage plane, rain screen, dimple board, or bleed layer to facilitate removal of moisture between the lightweight composite sheathing panels and exterior wall or roof structures.

Additional information and features relating to lightweight composite panels and their uses in making various building products are disclosed in U.S. Prov. App. No. 63/686,489, filed Aug. 23, 2024; U.S. Prov. App. No. 63/692,563, filed Sep. 9, 2024; U.S. Prov. App. No. 63/703,834, filed Oct. 4, 2024; U.S. Prov. App. No. 63/720,649, filed Nov. 14, 2024; U.S. Prov. App. No. 63/729,637, filed Dec. 9, 2024; U.S. Prov. App. No. 63/744,115, filed Jan. 10, 2025; U.S. Prov. App. No. 63/747,543, filed Jan. 1, 2025; U.S. Prov. App. No. 63/753,600, filed Feb. 4, 2025; U.S. Prov. App. No. 63/764,354, filed Feb. 27, 2025; U.S. Prov. App. No. 63/788,276, filed Apr. 14, 2025; U.S. Prov. App. No. 63/849,709, filed Jul. 23, 2025, U.S. Prov. App. No. 63/855,715, filed Aug. 1, 2025, U.S. Prov. App. No. 63/857,807, filed Aug. 5, 2025, and U.S. Prov. App. No. 63/862,235, filed Aug. 12, 2025. The foregoing applications are incorporated by reference in their entirety.

### III. Exterior Wall Structures and Roofing Decks

The lightweight composite sheathing panels can be fastened to an exterior side of an exterior wall or roof frame to form an exterior wall structure or roofing deck using mechanical fasteners and adhesives known in the art, such as wood screws, sheet metal screws, nails, rivets, and construction adhesive. Because the lightweight composite sheathing panels can be used to make exterior wall structures and roofing decks, screws or other mechanical fasteners are advantageously made from corrosion-resistant materials, such as stainless steel, galvanized steel, high strength polymers, and the like. Strips of tape (mesh or solid) that line up with underlying studs or other structural elements of the exterior wall or roof frame can be used as a template to ensure proper placement and securement of screws or other mechanical fasteners through the lightweight composite wallboards and into the studs or other structural elements of the exterior wall or roof frame. To prevent screws from tearing through the exterior fiber mesh reinforced cementitious (or other protective) layer, screws can be used with enlarged washers or pan head screws or screws with integrated washers having high surface area to distribute the pressure or load over a correspondingly higher surface area of the lightweight composite sheathing panels thus providing a higher pull-out force.

In some embodiments, specialized washers with penetrating prongs can be used. When screws are driven through the lightweight composite sheathing panels and into an underlying wooden or metal stud or other structural element of the exterior wall or roof frame, the prongs will penetrate into and become embedded within the lightweight composite sheathing panels, including at least the exterior fiber mesh reinforced cementitious (or other protective) layer and at least partially through the foam core. This prevents the washers from rotating out of place during placement and provides additional lateral strength to hold the lightweight composite sheathing panels in place relative to the exterior wall or roof frame. In addition, rectangular or other appropriately shaped washers with multiple prongs on either side of the screw can be used to tie adjacent lightweight composite sheathing panels together, which can improve the structural integrity and shear strength of the exterior wall structure or roofing deck.

In some embodiments, the length of penetrating prongs of the washers can be made to correspond to the cross-sectional thickness of the lightweight composite sheathing panels used to make an exterior wall structure. Advantageously, the length of the penetrating prongs can be slightly less than, equal to, or slightly exceed the cross-sectional thickness of the lightweight composite sheathing panels. This allows the penetrating prongs to penetrate all the way through the foam core and the interior fiber mesh reinforced cementitious (or other protective) layer and make abutment with studs, sheathing, or other structural element of the exterior wall or roof structure. This provides a stop that limits further movement of the enlarged washer toward the lightweight composite sheathing panels, preventing unwanted crushing of the lightweight composite sheathing panels and ensuring that the screw and washer ensemble does not break through and damage the exterior fiber mesh reinforced cementitious (or other protective) layer. However, it may be desirable for the length of the prongs to permit slight compression of the exterior fiber mesh reinforced cementitious (or other protective) layer without damaging it. This ensures that appropriately strong pressure is applied by the washer to the exterior fiber mesh reinforced cementitious or other protective) layer to securely fasten the lightweight composite sheathing panels to a wall or roof structure. Where the underlying studs or other structural element are metal, the length of the penetrating prongs can be approximately equal to or slightly less than the cross-sectional thickness of the lightweight composite sheathing panels. Alternatively, where the underlying studs, sheathing, or other structural elements are made of wood, the length of the penetrating prongs can be slightly greater than the cross-sectional thickness of the lightweight composite sheathing panels in order to for the prongs to partially penetrate into the wood, thereby potentially further increasing the lateral and shear strength provided by the lightweight composite panels of a wall or roof structure.

In some embodiments, the fiber mesh reinforced cementitious (or other protective) layers of the lightweight composite sheathing panels can have a grid pattern or other discontinuity that can facilitate adhesion of cementitious materials, stucco, adhesives, paint, or other coatings to exposed surfaces of the lightweight composite sheathing panels. For example, one or more stucco layers can directly adhere to the fiber mesh reinforced cementitious (or other protective) layer without the need for wire mesh, scratch coat, and brown coat used in conventional stucco systems. Nevertheless, it may be desirable to apply a layer of thin set mortar to cover screws, sealants, holes, or other discontinuities prior to applying a finished stucco layer (which can be cementitious or acrylic bases).

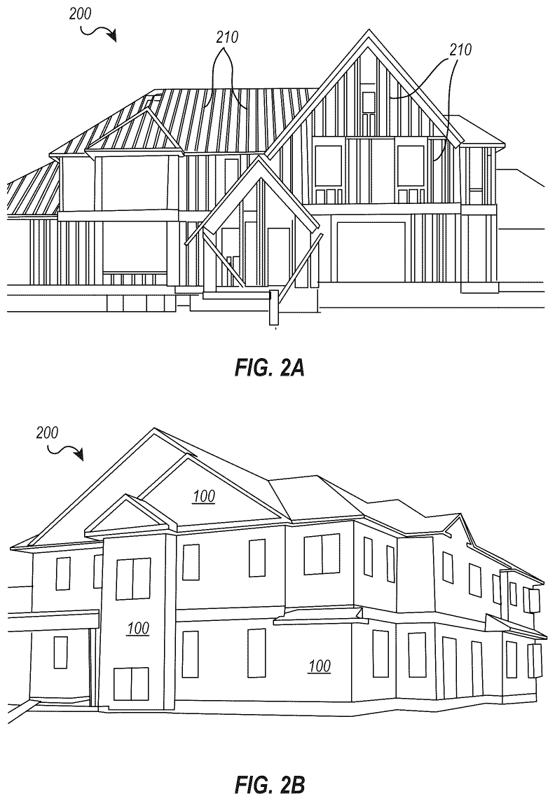

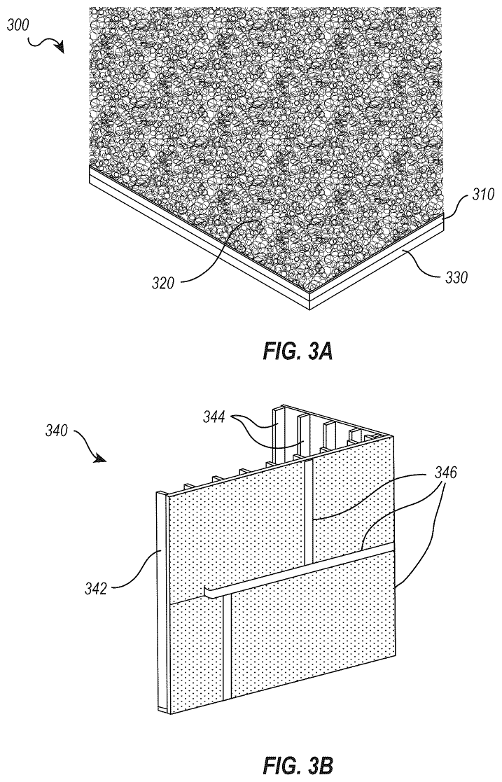

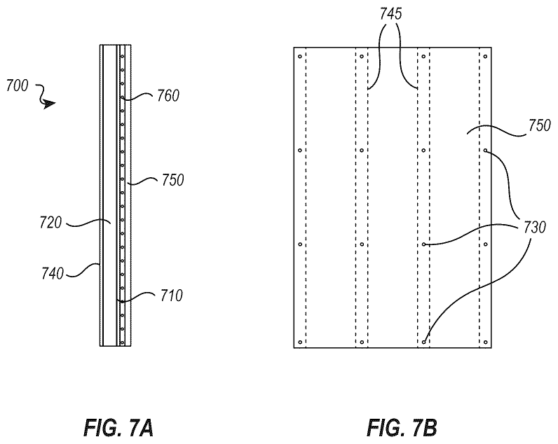

Reference is now made to FIGS. 6-13, which illustrate lightweight composite sheathing panels and fasteners used in making waterproof exterior wall structures or roofing decks instead of OSB or other conventional wooden board systems. Reference is also made to FIGS. 2 and 3, which can be modified to use lightweight composite sheathing panels instead of OSB cores.

By way of example, FIG. 2A illustrates a framed house 200 with studs that form exterior wall or roof frames to which lightweight composite sheathing panels can be attached to form exterior wall structures and/or roofing decks. FIG. 2B illustrates a framed house 200 that includes exterior shear walls and roofing deck formed using OSB panels 100, but which can be modified to instead use lightweight composite sheathing panels in place of some or all of the OSB panels. FIG. 3A illustrates a modified OSB panel 300 that includes an OSB core 310, a water-resistant barrier layer 320 on an exterior surface of the OSB core 310, and an insulating foam layer 330 on the exterior surface of the OSB core 310. FIG. 3B illustrates an exterior wall structure 340 made using modified OSB units 300, but which can be modified to instead use the lightweight composite sheathing panels disclosed herein in place of some or all of the modified OSB panels 300. The OSB panels 100 shown in FIG. 2B and the modified OSB panels 300 shown in FIG. 3B can be replaced with lightweight composite sheathing panels, such as those illustrated in FIGS. 4 and 5. FIG. 3B illustrates how joints or seams between adjacent OSB panels 300 can be sealed using flexible tape 436.

FIG. 6A illustrates an exterior wall structure or roofing deck 600 formed using a plurality of lightweight composite sheathing panels 610 positioned on an exterior side of an exterior wall or roof frame 620. FIG. 6B illustrates the lightweight composite sheathing panel 610 with example screws 630 or other mechanical fasteners used in attaching the lightweight composite sheathing panel 610 to individual metal or wood studs of the exterior wall or roof frame 620 of conventional spacing. For example, the screws or other attachment means can be spaced apart with 16-inch spacing between studs in the x-direction and 18-inch spacing in the y-direction).

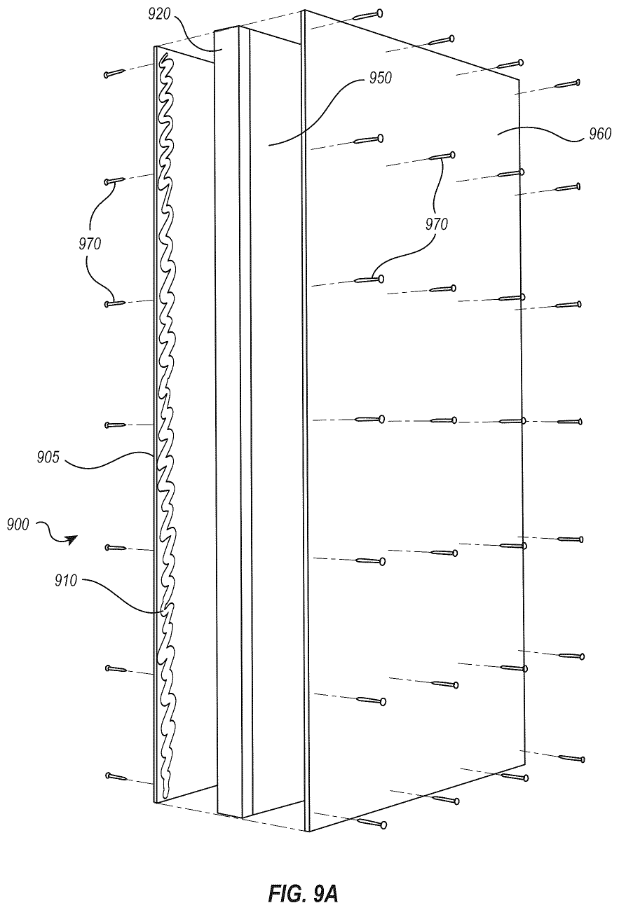

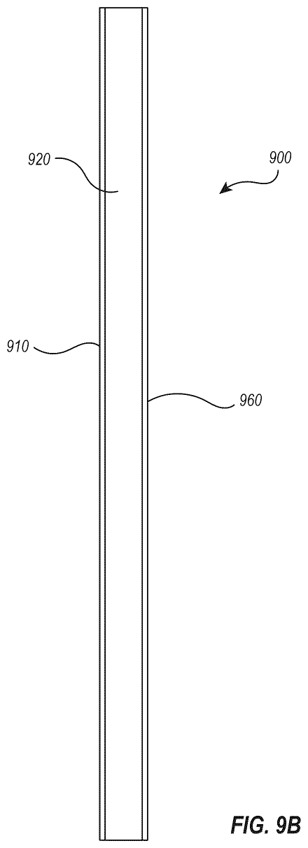

In addition to or instead of screws or other mechanical fasteners, an appropriate adhesive, such as construction adhesive, can be used to adhere the lightweight composite sheathing panels to the exterior wall or roof frame (see FIGS. 8 and 9A). The use of an adhesive can provide a continuous bond interface between the lightweight composite sheathing panels and studs of the exterior wall or roof frame, thereby distributing the load more evenly and improving shear strength of the exterior wall structure or roofing deck. Screws, nails, rivets, hangers, other mechanical fasteners, and adhesives are examples of means for fastening lightweight composite sheathing panels to studs or other structural elements of the exterior wall or roof frame 620.

Attaching the lightweight composite sheathing panel 610 to the exterior wall or roof frame 620 using one or more types of fastening means disclosed herein yields a strong exterior wall structure or roofing deck 600 that can function as a shear wall to form exterior wall structures or roofing decks of fixed dimensions.

FIG. 3B illustrates how joints or seams between adjacent lightweight composite sheathing panels (not shown) can be sealed using sealing means known in the art, such as flexible tape, mesh and cementitious composition, metal flashing, and the like. For example, joints or seams between adjacent lightweight composite sheathing panels 610, including on wall faces and corners, can be sealed using sealing tape similar to the sealing tape 346 illustrated in FIG. 3B used to seal joints or seams between modified OSB panels 300.

FIG. 6A further illustrates an optional interior composite layer 640, which can be formed using lightweight composite panels, or modified versions thereof, to form a complete wall system. Example composite panels that include core composite panel structures and interior finishes are disclosed in U.S. Provisional Application No. 63/686,489, filed Aug. 23, 2024, U.S. Provisional Application No. 63/692,563, filed Sep. 9, 2024, U.S. Provisional Application No. 63/703,834, filed Oct. 4, 2024, and U.S. Provisional Application No. 63/788,276, filed Apr. 14, 2025, which are incorporated by reference in their entirety.

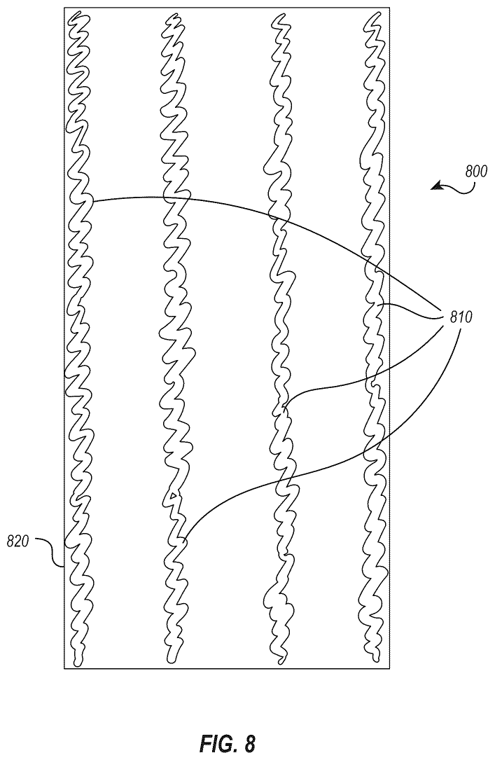

FIGS. 7A and 7B are similar to FIGS. 6A and 7B and illustrate an exterior wall structure or roofing deck 700 formed using a plurality of lightweight composite sheathing panels 710 positioned on an exterior side of an exterior wall or roof frame 720. An optional interior wall panel 740 is positioned on an interior side of the exterior wall or roof frame 720. FIGS. 7A and 7B further illustrate an outer decorative finish 750 on an exterior surface of the lightweight composite sheathing panels 710, such as stucco, brick veneers, stone and masonry, stone veneers, tiles, shingles, metal cladding, and the like. An optional rain screen or drainage plane 760 can be positioned between the lightweight composite sheathing panels 710 and the outer decorative finish 750.

FIG. 8 illustrates a lightweight composite sheathing panel 800 with spaced-apart beads of construction adhesive 810 used to fasten the lightweight composite sheathing panel 800 to an exterior wall or roof frame (not shown). The beads of construction adhesive 810 are positioned between the lightweight composite sheathing panel 800 and studs (not shown) of the exterior wall or roof frame to which the lightweight composite sheathing panel 800 is or will be attached. FIG. 8 also illustrates spacing and locations 820 for the optional placement of screws or other mechanical fasteners (not shown) that can be used to hold the lightweight composite sheathing panel 800 in a fixed position relative to the exterior wall or roof frame while the construction adhesive 810 hardens or cures. The use of construction adhesive 810 greatly increases the total attachment area between the studs or other structural elements to which the lightweight composite sheathing panel 800 is fastened, which greatly increases the shear strength of the resulting exterior wall structure or roofing deck. The screws 820 may add additional strength to the exterior wall structure or roofing deck but are mainly used to hold the lightweight composite sheathing panel 800 while the construction adhesive hardens or cures,

FIG. 9A is an exploded view of an example complete wall system 900 formed by fastening lightweight composite sheathing panels 905 to the exterior side of an exterior wall or roof frame 920 using non-corrosive screws 930, alone or in combination with construction adhesive 940. An insulation material 950, such as mineral wool or fiberglass, is placed between the studs of the exterior wall or roof frame 920. Drywall boards 960 can be fastened to the interior side of the exterior wall or roof frame 920 using standard drywall screws 970. The drywall boards 960 can include core structures comprising lightweight composite panels to which a surface layer has been applied, such as a plaster layer, paper layer, and/or cured polymer layer, as discussed herein and disclosed in U.S. Provisional Application Nos. 63/686,489, 63/692,563, 63/703,834, and 63/788,276, already incorporated by reference.

FIG. 9B is a cross-sectional view of the complete wall system 900 of FIG. 9A in assembled form, including lightweight composite sheathing panels 905 fastened to an exterior side of the exterior wall or roof frame 920 and drywall boards 960 fastened to an interior side of the exterior wall or roof frame 920.

In some embodiments, a method of constructing an exterior wall structure or roofing deck comprises: (1) forming or providing an exterior wall or roof frame comprising a plurality of studs or other structural elements; (2) fastening a plurality of lightweight composite sheathing panels to an exterior side of the exterior wall or roof frame, the lightweight composite sheathing panels each comprising: (a) a foam core (e.g., polymer or inorganic foam) having a first surface, a second surface opposite the first surface, a first edge forming a perimeter of the first surface, a second edge forming a perimeter of the second surface, and side surfaces extending between the first and second edges; (b) a first protective layer (e.g., first fiber mesh reinforced cementitious layer, thermoset polymer, or other rigid material) formed over and covering at least a portion of the first surface of the foam core; and (c) a second protective layer (e.g., second fiber mesh reinforced cementitious layer, thermoset polymer, or other rigid material) formed over and covering at least a portion of the second surface of the foam core, (d) wherein the lightweight composite sheathing panels are positioned so that one protective layer faces toward, and the other protective layer faces away from, the exterior side of the exterior wall or roof frame; and (4) sealing one or more joints or seams between adjacent lightweight composite sheathing panels.

In some embodiments, an exterior wall structure or roofing deck comprises: (1) an exterior wall or roof frame comprising a plurality of studs or other structural elements; (2) a plurality of lightweight composite sheathing panels fastened to an exterior side of the exterior wall or roof frame, the lightweight composite sheathing panels each comprising: (a) a foam core (e.g., polymer or inorganic foam) having a first surface, a second surface opposite the first surface, a first edge forming a perimeter of the first surface, a second edge forming a perimeter of the second surface, and side surfaces extending between the first and second edges; (b) a first protective layer (e.g., first fiber mesh reinforced cementitious layer, thermoset polymer, or other rigid material) formed over and covering at least a portion of the first surface of the foam core; and (c) a second protective layer (e.g., second fiber mesh reinforced cementitious layer, thermoset polymer, or other rigid material) formed over and covering at least a portion of the second surface of the foam core, (d) wherein the lightweight composite sheathing panels are positioned so that one protective layer faces toward, and the other protective layer faces away from, the exterior side of the exterior wall or roof frame; and (4) at least one of tape, polyurethane, or other sealant that seals one or more joints or seams between adjacent lightweight composite sheathing panels.

In some embodiments, the lightweight composite sheathing panels can be fastened to the studs or other structure elements of the exterior wall or roof frame by screws or other mechanical fasteners, which are spaced about at predetermined intervals, such as to match spacing between studs in the x-direction and with spacing in the y-direction to securely fasten the lightweight composite wallboards to the exterior wall or roof frame and form a shear wall. Alternatively, lightweight composite sheathing panels can be fastened to studs or other structural elements of an exterior wall or roof frame using construction adhesive instead of, or in addition to, screws or other mechanical fasteners, which can improve the shear strength of the exterior wall structure or roofing deck. Screws, mechanical fasteners, construction adhesives, and other fastening elements known in the art comprise means for fastening lightweight composite sheathing panels to studs or other structural elements of exterior wall or roof frames.

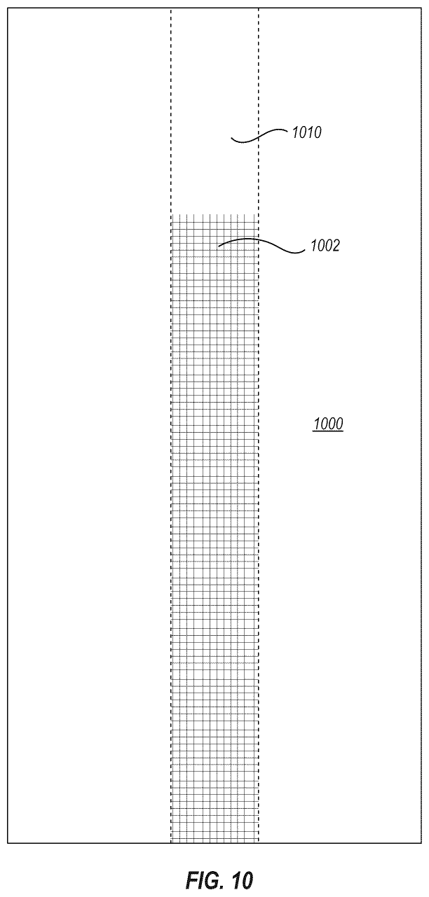

FIG. 10 illustrates the use of mesh tape 1002 that acts as a template for proper placement of screws or other mechanical fasteners when fastening a lightweight composite sheathing panel 1000 to studs or other structural elements 1010 of an exterior wall or roof frame. Placement of screws or other mechanical fasteners through the mesh tape 1002, preferably at or near the center line of the mesh tape 1002, helps ensure that the screws or other mechanical fasteners reliably engage the studs or other structural elements 1010 rather than being uselessly positioned outside the studs or other structural elements.

In some embodiments, the screws or other fasteners used to attach the lightweight composite wallboards to the exterior wall or roof frame include corresponding washers or enlarged heads also known as pan head screws or screws with integrated washers that are at least about 20 mm, 25 mm, 30 mm, 35 mm, 40 mm, 45 mm, 50 mm, 55 mm, 60 m, 65 cm, 70 cm, 75 mm, or 80 mm, in diameter. This ensures sufficiently large surface contact between the screws or other fasteners and the fiber mesh reinforced cementitious (or other protective) layer so that the screws or other fasteners have a much lower tendency to tear through the lightweight composite sheathing panels or otherwise compromise the structural integrity of the exterior wall structure or roofing deck.

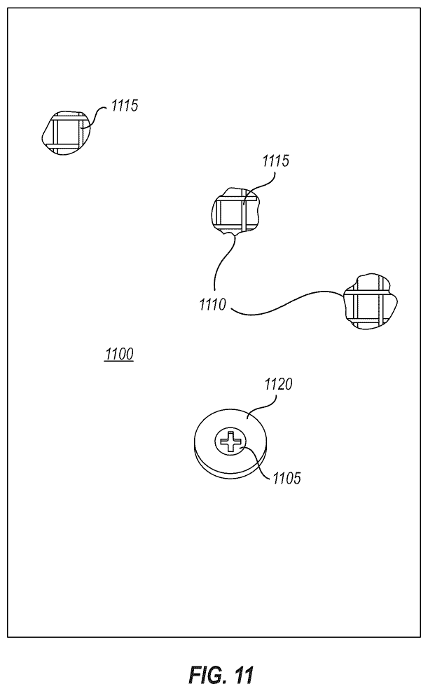

To illustrate this point, FIG. 11 illustrates a lightweight composite sheathing panel 1100 with holes 1110 formed by screws 1105 passing all the way through the exterior fiber mesh reinforced cementitious layer. Remnants 1115 of fiber mesh of the damaged fiber mesh reinforced cementitious layer can be seen. The holes 1110 are the result of screw heads being too small (i.e., having too little surface area) to prevent the screws and screw heads from perforating and penetrating all the all the way through the exterior fiber mesh reinforced cementitious layer. FIG. 11 further illustrates a screw 1105 with washer 1120 abutting the surface of the lightweight composite sheathing panel 1100 without having passed through the exterior fiber mesh reinforced cementitious layer.

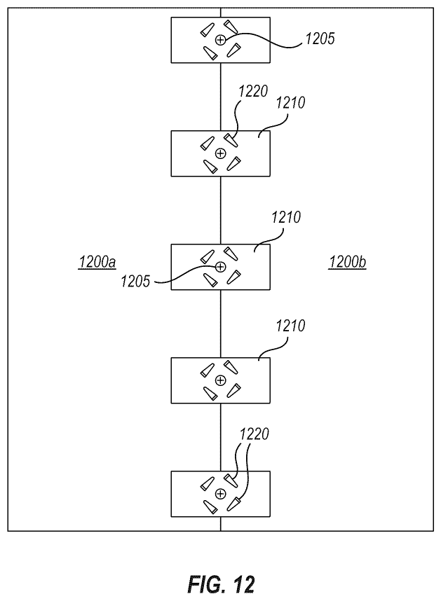

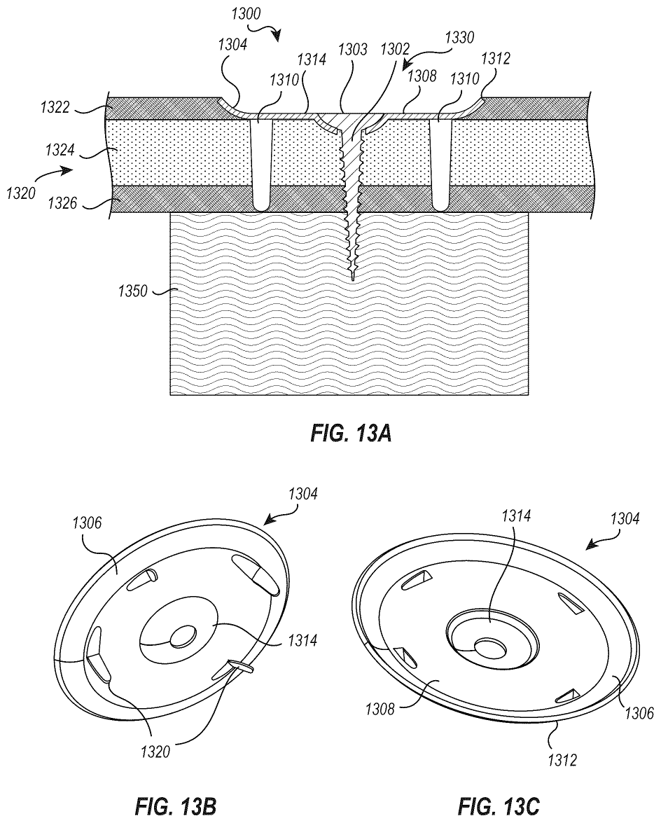

Reference is now made to FIGS. 12-13C, which illustrate the use of specialized washers with enlarged surface areas and penetrating prongs that help fix the washers in place relative to the lightweight composite sheathing panels, prevent rotation when screws are being driven into studs or other structural elements of an exterior wall or roof frame, and add additional lateral strength between the washers and the lightweight composite sheathing panels. The penetrating prongs can also be designed to abut the underlying stud or other structural element and act as a stop to prevent the washers from being driven too far into the lightweight composite sheathing panels and undesirably crushing or fracturing the exterior fiber mesh reinforced cementitious (or other protective) layer, which could greatly reduce the shear strength of the exterior wall structure or roofing deck.

FIG. 12 more particularly illustrates the use of screws 1205 and specialized washers 1210 having a plurality of penetrating prongs 1220. The specialized washers 1210 can be rectangular in shape in order to overlap the end surfaces of adjacent lightweight composite sheathing panels 1200a, 1200b. The penetrating prongs 1220 penetrate through and become embedded within the lightweight composite sheathing panels 1200a, 1200b, including penetrating though the exterior fiber mesh reinforced cementitious (or other protective) layers and at least partially through the foam cores of the lightweight composite sheathing panels. The penetrating prongs 1220 hold the specialized washers 1210 in a desired position relative to the lightweight composite sheathing panels 1200a, 1200b and prevent rotation while the screws are being driven through the lightweight composite sheathing panels and into the underlying studs or other structural elements of an exterior wall or roof frame. The penetrating prongs 1220 thereby ensure that left and right wings of the specialized washers 1210 reliably overlap corresponding surfaces of the left and right lightweight composite sheathing panels 1200a, 1200b tie them together. The penetrating prongs 1220 can also provide a load spreading/pressure spreading effect, i.e., the prongs 1220 distribute the normal and lateral pressure from the screw to the prongs. The specialized washers 1210 and penetrating prongs 1220 provide greater lateral tension of the screw and washer ensemble relative to the lightweight composite sheathing panels 1200a, 1200b, thereby increasing the overall shear strength of the exterior wall structure or roofing deck.

FIGS. 13A-13C illustrate a fastener assembly 1300 comprising a screw 1302 and specialized washer 1304 with enlarged surface area and penetrating prongs 1310 for attaching a lightweight composite building panel 1320 to a stud 1350 or other structural element. The penetrating prongs 1310 help fix the washer 1304 in place relative to the lightweight composite building panel 1320 prevent rotation of the washer 1304 when the screw 1302 is being driven into the stud 1350 or other structural element of a wall or roof structure and add additional lateral strength between the washers 1304 and the lightweight composite building panel 1320. The penetrating prongs 1310 can also be designed to abut the underlying stud 1350 or other structural element and act as a stop to prevent the washer 1304 from being driven too far into the lightweight composite building panel 1320 and undesirably crushing or fracturing the exterior fiber mesh reinforced cementitious (or other protective) layer 1322, which could reduce the strength of an exterior wall structure or roofing deck.

FIG. 13A more particularly illustrates the use of a specialized fastener assembly 1300 comprising a screw 1302 and specialized washer 1304 having a body 1306 of enlarged diameter, a concave interior portion 1308, and a plurality of penetrating prongs 1310 extending laterally from the washer body 1306. Although the specialized washer 1304 in this embodiment is illustrated as having a circular washer body 1306, other embodiments of specialized washers may include enlarged rectangular-shaped washer bodies (not shown) designed to more completely overlap and adjoin adjacent lightweight composite panels during installation.

The penetrating prongs 1310 are designed to penetrate through and become embedded within a lightweight composite sheathing panel 1320, including though the exterior fiber mesh reinforced layer 1322, at least partially through the foam core 1324, and optionally through the interior fiber mesh reinforced layer 1326 and drainage layer (not shown) so as to make abutment with a stud 1350 or other structural element of a wall or roof frame. The penetrating prongs 1310 help retain the specialized washers 1304 in a desired position relative to the lightweight composite sheathing panel 1320 and prevent rotation while the screw 1302 is being driven through the lightweight composite panel 1320 and into the underlying stud 1350 or other structural element of a wall or roof structure. The penetrating prongs 1310 can also provide a load spreading/pressure spreading effect to distribute normal and lateral pressure from the screw 1302 and washer body 1306 to the prongs 1310. The specialized washer 1304 and penetrating prongs 1310 provide greater lateral tension of the screw and washer assembly 1300 relative to the lightweight composite building panel 1320, thereby increasing the overall shear strength of a wall or roof structure.

FIG. 13B is a bottom perspective view and FIG. 13C is a top perspective view of the specialized washer 1304, which more particularly illustrate features of the specialized washer 1304. The washer body 1306 can have an enlarged diameter in order to provide higher surface area and increase contact between the specialized washer 1304 and an adjacent fiber reinforced cementitious (or other protective) layer of a lightweight composite sheathing panel 1320. The washer body 1306 can have a concave interior portion 1308, which permits an outer rim 1312 to become substantially flush with, and the concave interior portion 1308 to advance below, the adjacent fiber reinforced cementitious (or other protective) layer when used to attach a lightweight composite building panel 1320 to a wall or roof structure, as shown in FIG. 13A. This allows the concave interior portion 1308 to partially compress the interior foam core 1324 and exterior fiber reinforced cementitious (or other protective) layer 1322 of the lightweight composite sheathing panel 1320 to provide firm and reliable attachment of the panel to the wall or roof structure. The washer body 1306 can include a countersink 1314 that accommodates the head 1303 of the screw 1302 so that the screw head 1303 does not protrude beyond the surface of the washer body 1306 when driven into a stud 1350 or other structural element of a wall or roof frame.

The length of the penetrating prongs 1310 can be selected to determine and limit how far the concave interior portion 1308 of the washer body 1306 is able to advance into and compress the lightweight composite sheathing panel 1320, forming a depression therein. The penetrating prongs 1310 can advantageously have a length in order to penetrate all the way through the lightweight composite sheathing panel 1320 and make contact with the stud 1350 or other structural element. In this way the penetrating prongs 1310 can act as a stop that limits how far the specialized washer 1304 can be driven toward and into the lightweight composite sheathing panel 1320. Providing a stop prevents the specialized washer 1304 from being driven too far into the lightweight composite sheathing panel 1320, thereby preserving the structural integrity and strength of the exterior fiber mesh reinforced cementitious (or other protective) layer 1322 adjacent to the specialized washer 1304. This preserves and maximizes the overall strength, including shear strength, of the wall structure.

In some embodiments, it may be desirable for the length of the penetrating prongs 1310 to be slightly less than the cross-sectional thickness of the lightweight composite sheathing panel 1320 in order to superficially compress, but not damage, the exterior fiber mesh reinforced cementitious (or other protective) layer 1322 toward the polymer foam core 1324 to thereby increase the compressive force of the washer 1304 bearing against the lightweight composite sheathing panel 1320. This can increase the overall fixation strength of the fastening assembly 1300.

In some embodiments, sealing one or more joints or seams between adjacent lightweight composite sheathing panels includes applying waterproof tape, metal flashing, polyurethane foam, fiber mesh tape and an appropriate seam coat (e.g., thin set mortar or fine sanded stucco), or other sealing means known in the over the joints or seams, including joints or seams in the wall or roofing deck face and corners. In addition, joints, seams, openings, or gaps between lightweight composite sheathing panels and other structural elements, such as wooden or metal beams or posts, vent pipes in roofs, fixtures, and the like, can be filled using sealing means known in the art, such as polyurethane foam, metal flashing, or tar.

In some embodiments, a thin cementitious layer or seam coat, such as thin set mortar, can be applied over at least a portion of the exterior facing fiber mesh reinforced cementitious (or other protective) layer, including over any exposed screws, washers, or other mechanical fasteners used to attach the lightweight composite sheathing panels to the exterior wall or roof frame, and over any joints or seams, tape, polyurethane, or other exposed sealants on or in the exterior wall structure.

In the case where the studs 1350 or other structural elements are wood so as to permit some degree of penetration by the penetrating prongs 1310, the length of the penetrating prongs 1310 can slightly exceed the cross-sectional thickness of the lightweight composite sheathing panels 1320. In such case, the penetrating prongs 1310 can be allowed to penetrate and bite slightly into the wood stud 1350 or other structural elements while still acting as a stop that prevents excessive penetration into the lightweight composite sheathing panels 1320 and avoiding damage to the exterior fiber mesh reinforced cementitious (or other protective) layer 1322. Penetration of the penetrating prongs 1310 into the wood studs 1350 or other structural elements of the exterior wall or roof frame can provide additional lateral fixation between the lightweight composite sheathing panels 1320 and the exterior wall or roof frame. This can further help tie adjacent lightweight composite sheathing panels 1320 together and increase shear strength of the exterior wall structure or roofing deck.

In some embodiments, a foam insulation layer can be positioned between the lightweight composite sheathing panels and the exterior wall or roof frame. This can be useful in case it is desirable to increase the R-value of the exterior wall structure of roofing deck without using lightweight composite sheathing panels of high cross sectional thickness. In some embodiments, the foam insulation layer may comprise polyisocyanurate foam.

The exterior wall structures and roofing decks and roofing decks disclosed herein have a number of advantageous features, such as being waterproof and fire resistant compared to OSB panels. They can also be air-tight in order to support a growing trend that promotes energy efficiency and better control of air quality in a building environment.

In summary, the lightweight composite sheathing panels, when used to form exterior wall structures and roofing decks, can have the following advantages over exterior wall structures and roofing decks made using conventional or modified OSB panels.
lightweight composite sheathing panels can replace traditional OSB sheathing;
they can be applied directly to various substrates or framing (wood/metal studs) using either mechanical fasteners or chemical adhesives;
this system reduces the number of layers required between the internal structure and the final exterior finish, offering improved waterproofing, insulation, vapor permeability, and mold resistance.
when sealed with seam coat or seam tape the panels can act as an integrated water-resistive barrier (WRB) within the core, eliminating the need for separate house wrap or membranes

A traditional OSB sheathing system typically requires the following steps:
1. installing OSB sheathing over the structure (e.g., studs);
2. applying a polymer house wrap (such as Tyvek) over the OSB sheathing for weather protection;
3. using sealants or flashing around joints and openings to prevent water intrusion; and
4. applying exterior finish cladding (siding, stucco system, or other) over the wrapped OSB sheathing.

By comparison, the disclosed method and system includes the following simplified steps:
1. installing lightweight composite sheathing panels over the wall or roof frame (e.g., studs);
2. using polyurethane or other sealing foam around joints and fenestration openings to complete the integrated WRB system and prevent water intrusion; and
3. applying exterior finish cladding (siding, stucco system, or other) directly to the exterior surfaces of the lightweight composite sheathing panels.

The disclosed method and system provide the following benefits compared to traditional OSB sheathing systems:
1. Simplified layering:
   lightweight composite sheathing panels eliminate the need for both OSB units and house wrap, serving as both structural sheathing and water resistant barrier (WRB);
   This reduction in layers results in faster installation and fewer materials.
2. Waterproofing at joints:
   while OSB sheathing relies on house wrap and careful sealing at joints, the disclosed systems incorporate waterproof tape or other methods to seal joints directly, enhancing moisture resistance with fewer steps.
3. Fire resistance:
   standard OSB panels lack fire resistance, whereas lightweight composite sheathing panels offer built-in fire rating compliance, achieving an ASTM E84 Class A rating, without additional coatings or treatments.
4. Mold and Moisture Protection:
   OSB panels are susceptible to mold and swelling if exposed to moisture;
   the moisture-resistant core of the disclosed lightweight composite sheathing panels eliminates these risks, improving durability in wet environments.
5. Labor and cost savings:
   by reducing the number of layers (no need for OSB panels, house wrap, or additional waterproofing steps), use of the disclosed lightweight composite sheathing panels saves labor time and lowers material costs.

The disclosed method and system provide the following benefits compared to modified OSB systems, such as ZIP System. The ZIP System process:
combines OSB sheathing with an integrated water-resistant barrier, eliminating the need for traditional house wrap;
joints are sealed with proprietary ZIP tape to ensure air and moisture resistance.
install ZIP system sheathing over the structure (e.g., studs).

In contrast, the following is a comparison between the disclosed method and system and the ZIP System:
1. Integrated waterproofing:
   similar to the ZIP system, the disclosed method and system uses waterproof tape to seal joints between adjacent lightweight composite sheathing panels, ensuring effective moisture management.
   however, the lightweight composite sheathing panels used in the disclosed method and system combines sheathing with a bonding surface for stucco and other finishes, reducing layers and materials.
2. Enhanced fire resistance:
   The ZIP system sheathing provides weather resistance but does not offer inherent fire protection (i.e., the OSB core is still made from wood and can burn similar to standard OSB units;
   lightweight composite wallboards integrate fire resistance, streamlining compliance with building codes;
   Composite panels achieve an ASTM E84 Class A flame spread rating, providing superior fire performance without additional coatings or treatments.
3. Design flexibility:
   While the ZIP system is mainly intended for use under standard siding or cladding, lightweight composite sheathing panels of the disclosed method and system support multiple exterior finishes, including stucco, acrylic coatings, and brick veneer, enhancing architectural options.

### IV. Additional Terms & Definitions

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. A method of constructing an exterior wall structure or roofing deck, comprising:
forming or providing an exterior wall or roof frame comprising a plurality of studs, trusses, or other structural elements;
fastening a plurality of lightweight composite sheathing panels to an exterior side of the exterior wall or roof frame, wherein the lightweight composite sheathing panels each comprise:
a foam core having a first surface and a second surface opposite the first surface;
a first protective layer selected from a first fiber reinforced cementitious layer, thermoset polymer layer, or magnesium oxide layer formed over and covering at least a portion of the first surface of the foam core; and
a second protective layer selected from a second fiber reinforced cementitious layer, thermoset polymer layer, or magnesium oxide layer formed over and covering at least a portion of the second surface of the foam core,
wherein the lightweight composite sheathing panels are positioned so that one protective layer faces toward, and another protective layer faces away, from the exterior side of the exterior wall or roof frame; and
sealing one or more joints or seams between adjacent lightweight composite sheathing panels.

2. The method of claim 1, wherein the exterior wall or roof frame comprises at least one of wooden studs or trusses or metal studs or trusses.

3. The method of claim 1, wherein each of the lightweight composite sheathing panels is fastened to studs, trusses, or other structure elements of the exterior wall or roof frame by a plurality of screws, other mechanical fasteners, such as screws or other fasteners spaced about at predetermined intervals, and/or an adhesive applied between the lightweight composite sheathing panels and the exterior side of the exterior wall or roof frame.

4. The method of claim 4, wherein the screws or other mechanical fasteners include corresponding washers or enlarged heads, pan head screws, or screws with integrated washers that are at least about 20 mm, 25 mm, 30 mm, 35 mm, 40 mm, 45 mm, 50 mm, 55 mm, 60 m, 65 cm, 70 cm, 75 mm, or 80 mm, in diameter to prevent penetration of and damage to the lightweight composite sheathing panels thus providing a higher pull-out force.

5. The method of claim 5, wherein the washers further include a plurality of penetrating prongs configured to penetrate at least partially through the lightweight composite sheathing panels, including through an exterior facing protective layer and at least partially through the foam core, such as where the penetrating prongs penetrate all the way through the lightweight composite sheathing panels and make abutment with the studs, trusses, or other structure elements.

6. The method of claim 1, wherein sealing one or more joints or seams between adjacent lightweight composite sheathing panels includes applying waterproof tape over the joints or seams.

7. The method of claim 1, further comprising placing polyurethane or other sealant into the joints or seams or other openings or gaps between or adjacent to the lightweight composite sheathing panels.

8. The method of claim 1, wherein the lightweight composite sheathing panels, when fastened to the exterior wall, form a shear wall that helps maintain the exterior wall structure in a desired shape and position.

9. The method of claim 1, wherein the foam core comprises a polymer selected from the group consisting of extruded polystyrene (XPS), expanded polystyrene (EPS), polyisocyanurate, polyurethane (PUR), phenolic polymers (e.g., phenol-formaldehyde), melamine polymers (e.g., melamine-formaldehyde), and other thermoplastic and thermoset polymers that can be formed into a rigid or semi-rigid polymer foam structure.

10. The method of claim 1, wherein the foam core comprises an inorganic foam material selected from the group consisting of silica gel, aerogel, silicate foams, urea-silicate foams, SiOC/SiC, ceramic foams, and refractory foams.

11. The method of claim 1, wherein at least one of the first or second fiber reinforced cementitious layers is included and comprises fiber reinforcement embedded within a hardened cementitious composition.

12. The method of claim 12, wherein the fiber reinforcement is selected from fiber mesh, alkali-resistant fiberglass mesh, embedded fibers, fabric, woven, scrim, felt, and non-woven, wherein the fiber reinforcement comprise at least one of plant fibers, polymer fibers, and inorganic fibers, which are selected from fibers or filaments formed from glass, basalt, rock wool, or carbon.

13. The method of claim 12, wherein the at least one of the first or second fiber reinforced cementitious layers has a cross-sectional thickness in a range of about 0.5 mm to about 3 mm, or about 0.75 mm to about 2.5 mm, or about 1 mm to about 2 mm, or about 1.25 mm to about 1.75 mm.

14. The method of claim 1, wherein at least one of the first or second thermoset polymer layers is included and comprises polyurea or polyaspartic and is optionally fiber-reinforced.

15. The method of claim 15, wherein the at least one of the first or second thermoset polymer layers has a cross-sectional thickness in a range of about 1 mm to about 5 mm, or about 2 mm to about 4 mm.

16. The method of claim 1, further comprising applying a thin cementitious layer, such as thin set mortar, over at least a portion of the lightweight composite sheathing panels, including over any exposed screws or other mechanical fasteners used to fasten the lightweight composite sheathing panels to the exterior wall or roof frame, and over any joints or seams, tape, polyurethane, or other exposed sealants on or in the exterior wall structure.

17. The method of claim 1, further comprising applying or attaching one or more exterior finish layers or features, such as stucco, brick veneers, stone and masonry, or other finishing layer, to the lightweight composite sheathing panels.

18. The method of claim 1, further comprising positioning an insulation layer between the lightweight composite sheathing panels and the exterior wall or roof frame, such as where the insulation layer comprises polyisocyanurate foam.

19. An exterior wall structure or roofing deck formed according to the method of claim 1.

20. An exterior wall structure or roofing deck, comprising:
an exterior wall or roof frame comprising a plurality of studs, trusses, or other structural elements;
a plurality of lightweight composite sheathing panels fastened to an exterior side of the exterior wall or roof frame, wherein the lightweight composite sheathing panels each comprise:
a foam core having a first surface and a second surface opposite the first surface;
a first protective layer selected from a first fiber reinforced cementitious layer, thermoset polymer layer, or magnesium oxide layer formed over and covering at least a portion of the first surface of the foam core; and
a second protective layer selected from a second fiber reinforced cementitious layer, thermoset polymer layer, or magnesium oxide layer formed over and covering at least a portion of the second surface of the foam core,
wherein the lightweight composite sheathing panels are positioned so that one protective layer faces toward, and another protective layer faces away, from the exterior side of the exterior wall or roof frame; and
at least one of tape, polyurethane, or other sealant that seals one or more joints or seams between adjacent lightweight composite sheathing panels.
